(19) United States
(12) Patent Application Publication
(10) Pub. No.: US 2007/0169372 A1
(43) Pub. Date: Jul. 26, 2007

(54) Dehumidifier drier for pastes, liquors and aggregate materials

(76) Inventors: Eric William Scharpf, Port Chalmers (NZ); Cedric Gerald Carrington, Dunedin (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/561,703

(22) PCT Filed: Jun. 24, 2004
(86) PCT No.: PCT/NZ04/00133

§ 371 Date: Mar. 5, 2007

(30) Foreign Application Priority Data
Jun. 24, 2003 (NZ) 526648

(51) Int. Cl. F26B 21/06; F26B 3/00

(52) U.S. Cl. 34/468; 34/73; 34/77

(57) ABSTRACT

A process and apparatus for drying pastes, liquors and aggregate materials by means of a heat integrated and/or heat pumping process and/or apparatus is disclosed. This includes a heat pump or heat integrated apparatus operable in a drying apparatus with the heat pump evaporator (36) or cold heat exchanger in primary thermal contact with the drying gas medium (33) after said drying gas medium (33) has taken up moisture from the material being dried (35) and the heat pump condenser (14) or hot heat exchanger (36) in primary thermal contact with the material being dried and with both the drying gas medium (33) and any heat pump refrigerant in nominally closed loop circulation paths (22). This process and apparatus may provide improved efficiency and reduced costs by reducing the required flow of drying gas through the system since that drying gas is no longer the primary means for supplying heat to the material being dried.

### FIELD OF THE INVENTION

The present invention relates to the drying of materials using a heat pump or heat integrated dehumidifier system to move energy to evaporate liquid from wet material. It has particular application to the drying of materials in a nominal paste, wet liquor or aggregate form but is also well suited for numerous other drying processes.

### BACKGROUND TO THE INVENTION

Most pastes and similar wet liquors dried on an industrial scale are currently dried by systems operating on a heat-and-vent principle where ambient air or other drying gas is heated by indirect contact with steam or by some other high temperature heat source, passed over or through the paste, liquor or other material to be dried, and vented back to the atmosphere. This process is often relatively rapid but energy inefficient and can emit a large vapour plume that is undesirable in many cases.

The problem of the highly prominent vapour plume is associated with the warm wet drying gas vented from the unit. In some implementations, these emissions can contain volatile organic products, including hazardous air pollutants. Even when it does not contain polluting components, the vapour plume is a clear indication of industrial activity that has become undesirable in many situations. This plume is also a problem in that it prevents the recovery of the moisture removed from the process which may have value in certain instances. This problem can be addressed by either removing the condensable material from the exhaust stream before it is exhausted to the environment or in preparation to recirculate it back through the drying system. Although these methods are known in the art, it is often expensive to implement such processes.

One way to improve the efficiency problem for existing heat and vent processes is to recover some of the heat present in the drying gas after it has taken up moisture from the material being dried. This is known in the art and has led to several patents on various ways to recover this heat. One such patent, U.S. Pat. No. 4,466,202 by Merten, proposes a variation on the commonly used vapour recompression process. In Merton's process, a drying gas is recirculated through the drier and the moisture vapour taken up by the drying gas is separated out by a semi-permeable membrane. This moisture vapour is then compressed and condensed with the heat of condensation used to either heat the incoming drying gas or the material being dried before it is removed from the process.

Although Merton's process can improve efficiency and eliminate the vapour plume, there are several significant disadvantages. The first is that the membrane system for separating the moisture vapour from the drying gas is expensive and causes a significant pressure drop in both the moisture vapour and drying gas streams which must be overcome by compressor systems. The second is that the resulting low pressure of the permeate vapour stream will require a large volume capacity compressor which significantly increases the cost of the process. A third disadvantage is that the process is constrained by the requirement that the compressor and heat recovery system be specifically designed around the thermodynamic and refrigeration properties of the type of moisture being removed from the process and must deal with any less than optimum behaviours of that moisture species.

Heat pump systems have also been used to improve the efficiency of the drying process yet avoid this limitation by the thermodynamic refrigeration properties of the moisture being removed. U.S. Pat. No. 4,134,216 by Stevens proposes a heat pump system with a closed loop refrigerant cycle and a closed loop drying gas cycle where the heat pump continuously recovers the heat of condensation from the moisture laden drying gas and recycles it into the moisture lean drying gas before it contacts the material being dried. U.S. Pat. No. 4,247,991 by Mehta proposes a similar process with a supplemental drying gas desiccant added to generate further improvement. Although both of these processes improve the efficiency and eliminate the vapour plume in a more flexible way, they both have the disadvantage of returning heat to the process through the drying gas medium. This requires a large area for heat exchange, a large flow or high temperature for the drying gas, and a higher pressure drop or inefficient heat pumping to and from the drying gas as it moves through the process.

Another heat pump drying system is described in U.S. Pat. No. 5,537,758 by Guarise. This apparatus seeks to speed up a heat pump based drying process similar to the one described in U.S. Pat. No. 4,134,216 by adding a pre-drying chamber. The heat of evaporation to drive this pre-drying chamber is either supplied directly to the material being dried by a high frequency electric field in an induction heating configuration similar to a microwave oven or through a separate hot air stream which is heated by a source separate from the heat pump circuit. Although such a system should produce a faster overall drying rate, it will be extremely inefficient and expensive in its operation of the pre-drying chamber. These disadvantages result from the lower efficiency of high frequency induction heating in this environment and the high flows or high temperatures required for the drying gas (air) to provide the large heat of evaporation for the moisture being removed.

A non-heat pump based drying process and apparatus proposed by Stevens and Peeters in U.S. Pat. No. 5,600,899 identifies another method to improve the uptake of the heat of evaporation by the material being dried. Their system also uses a heated drying gas to supply this heat of evaporation but employs a gas permeable conveyor belt to transport the material being dried. In this way, the heated drying gas can more effectively transfer heat to the material being dried. However, as with the other heated gas methods, this process requires significant fan power to overcome the pressure drop across the permeable belt and either a high temperature gas or a high flow of gas to transport the required amount of heat to evaporate the moisture. As a result, the process and apparatus proposed in U.S. Pat. No. 5,600,899 will be relatively costly and inefficient.

In U.S. Pat. No. 5,862,609, Steven and Peters propose a variation on their U.S. Pat. No. 5,600,809 process and system which is more amenable to use of a heat pump. This variation can more readily take advantage of the improved efficiency provided by a heat pump system by way of its multiple stages of closed loop drying gas circulation through their permeable conveyors. However, the high fan power costs associated with moving the large amounts of drying gas required will leave it with a cost and efficiency disadvantage.

Thus, although there have been numerous attempts to improve the efficiency and effectiveness of drying pastes, liquors and aggregate materials, there is still opportunity for further improvements.

### SUMMARY OF THE INVENTION

It is an object of the present invention to provide an improved drying process and/or an apparatus for drying by means of a heat integrated and/or heat pumping process and/or apparatus.

In one aspect the present invention may be said to consist of a heat pump or heat integrated apparatus operable in a drying apparatus with the heat pump evaporator or cold heat exchanger in primary thermal contact with the drying gas medium after said drying gas medium has taken up moisture from the material being dried and the heat pump condenser or hot heat exchanger in primary thermal contact with the material being dried and with both the drying gas medium and any heat pump refrigerant in nominally closed loop circulation paths.

In another aspect the present invention may be said to consist of a heat pump and drying apparatus including a drying chamber and a heat exchange apparatus, wherein the heat exchange apparatus includes a colder heat pump evaporator or heat integrated heat exchanger(s) and a hotter heat pump condenser or heat integrated heat exchanger(s) arranged such that during operation, the colder heat exchanger(s) substantially exchanges heat with the moisture rich drying gas stream, and the hotter heat exchanger(s) substantially exchanges heat with the material being dried rather than the moisture lean drying gas stream.

In another aspect the present invention may be said to consist in a heat pump driven drying process, wherein the heat exchange is performed though a colder heat pump evaporator or heat integrated heat exchanger(s) and a hotter heat pump condenser or heat integrated heat exchanger(s) arranged such that during operation, the colder evaporator or heat integrated heat is exchanged substantially with the moisture rich drying gas stream, and the hotter condenser or heat integrated heat is exchanged substantially with the material being dried rather than the moisture lean drying gas stream.

The hotter and colder heat exchange apparatus are primarily driven by the heat pump cycle through its respective condenser and evaporator. However, both heat exchange apparatus may utilise other integrated heat exchange technology. For example, other heat sinks and sources may be used to augment or replace the heat pump evaporator and condenser.

Preferably, the invention provides a higher efficiency process through the more direct heat exchange with the material being dried as well as a reduced capital cost process by way of the reduced drying gas requirements. These reduced drying gas requirements will come from the fact that the drying gas will have a higher capacity to take up moisture relative to its capacity to provide the heat needed to take up that moisture.

A preferred embodiment of the invention consists of a heat pump drying process and apparatus configured so that the heat pump condenser and evaporator are located entirely within a nominally enclosed chamber and work effectively with the primarily closed loop recirculating air-flow (or other drying gas medium). The method and apparatus of the invention conducts the drying gas cooling and moisture condensation heat exchange at the heat pump evaporator and does not directly heat the drying gas stream in any substantial way but instead provides the primary heat for drying from the heat pump condenser to the material being dried rather than through intermediate heat exchange with the drying gas stream as is done with conventional heat pump dehumidifier drying systems.

In optional embodiments employing heat integrated processes and apparatus, it is possible to use a waste heat source to supplement or replace the heat pump condenser and a waste heat sink such as cooling water to supplement or replace the heat pump evaporator.

In the preferred embodiment of the invention, in each pass through the heat pump system, all or part of the drying gas passes over the heat pump evaporator where some of the moisture is condensed out and heat is recovered from the drying gas stream. The drying gas stream then primarily takes up heat through contact with the material being dried and mixing with the moisture vapour evaporating from the material being dried rather than more directly through heat exchange with the heat pump condenser.

As with other existing heat pump systems, for low humidity operation, the drying capacity and efficiency of the invention can be optionally enhanced by recovering sensible cooling at the evaporator using a pair of liquid coupled or heat-pipe coupled heat exchangers at the evaporator (Blundell, 1979).

As those skilled in the art will appreciate, the process and apparatus of this invention will provide benefits to drying many different materials. These materials include but are not limited to sewage sludge, meat and vegetable matter processing streams and wastes, dairy processing streams and wastes, paper, bricks, gypsum, plaster board, textiles, china clay, fertilizer, dye stuffs, tiles, pottery, grain, nuts, seeds, fruits, bio-processing waste, etc.

The process and apparatus of this invention are also amenable to various drying gas mediums. Although the preferred embodiment for the invention is with air as the drying gas, the process and apparatus can be configured to use O₂-free air, nitrogen, argon, oxygen, or any other gaseous medium to take up the moisture from the materials to be dried and condense that moisture out of the system through the heat pump evaporator as noted in (Chen, Bannister, McHugh, Carrington, Sun, 2000) for other more traditional heat pump drying systems. As with other existing heat pump systems, the invention requires means for rejecting excess heat from the drying chamber. This may include full time or periodic venting of a sub-stream of the drying gas, cooling the drying gas entering the evaporator, cooling any make-up or purge drying gas entering or leaving the apparatus, sub-cooling the liquid heat pump refrigerant leaving the condenser, cooling the heat pump refrigerant leaving the compressor, or cooling and partially or wholly condensing the high-pressure refrigerant for purposes of control.

Also, although the system is preferentially focussed on water removal, it can also be configured to remove other vaporisable and condensable liquids from the material to be dried such as various organic solvents to be recovered from solvent based processing steps.

### BRIEF DESCRIPTION OF THE DRAWINGS

Preferred embodiments of the invention will be described with reference to the accompanying drawings, of which:

FIG. 1 shows a basic heat pump process flow diagram applicable to this invention,

FIG. 2 shows a preferred heat exchanger and drying chamber configuration with a belt system for conveying the material to be dried, and

FIG. 3 shows a preferred condenser heat exchanger configuration with a belt system for conveying the material to be dried.

### DETAILED DESCRIPTION OF THE PREFERRED EMBODIMENTS

The present invention is a process and apparatus to improve the heat pump based or heat integrated drying of liquors, pastes and other similar free flowing materials. A preferred embodiment of the invention involves exchanging heat between the heat pump evaporator and the moisture laden drying gas stream to partially condense and remove the moisture from the drying gas stream and involves exchanging heat between the heat pump condenser and the material being dried nominally without directly heating the drying gas stream in any substantial way except through contact with the material being dried and through mixing with the moisture vapour evaporating from the material being dried.

The following description of the process and apparatus of this invention, by way of example only and with reference to the accompanying drawings in the accompanying figures, indicates the presently preferred embodiments of the invention.

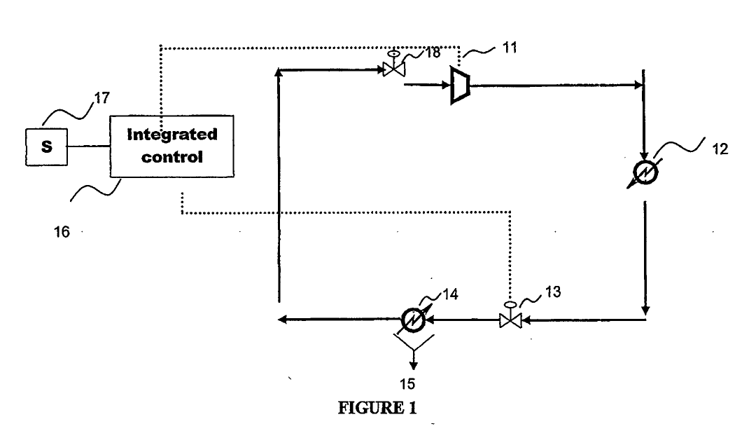

Referring to FIG. 1, the basic heat pump cycle is put forward with the primary sequence of processes for the refrigerant cycle of compression 11, condensation 12, expansion 13 and evaporation 14 with the drain 15 to indicate the removal of condensed liquid from the drying gas stream (not shown) at the evaporator 14. The heat pump system is controlled by integrated control unit 16 through signals from one or more sensors 17 and though one or more actuation devices 18. The designation of item 18 as a compressor suction control valve is simply one option for control actuation.

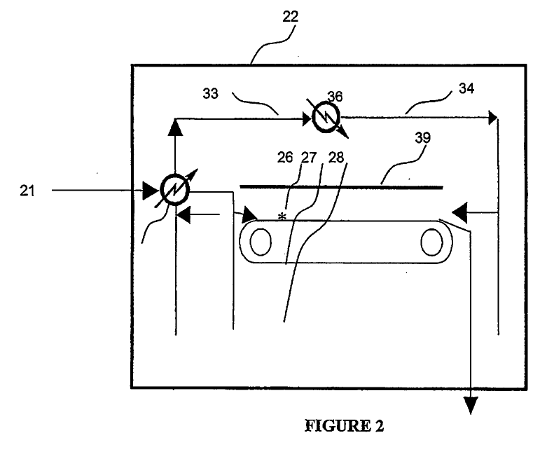

In the context of a dehumidifier drying system, referring to FIG. 2, the heat pump compressor (not shown) operates to move heat from the lower temperature evaporator heat exchanger (or exchangers) 36 to the higher temperature condenser heat exchanger or exchangers 29, 30 and 31. The heat pump evaporator 36 acts to remove heat from the drying gas 33 and condenser heat exchangers 29, 30 and 31 act to provide heat to the material being dried.

The drying gas is primarily recirculated through the system. Moisture laden drying gas stream 33 passed over heat pump evaporator heat exchanger 36 which cools and partially condenses moisture vapour from the drying gas and drains that condensed moisture from the system by gravity or other appropriate mechanism (not shown). The moisture lean drying gas stream 34 then is channelled over the material being dried, which is spread out over a belt conveyor system 23, 24 and 25. There the drying gas takes up moisture evaporating from the material being dried and then as stream 35 optionally provides heat to the incoming material being dried through exchanger 37 before it recycles again through the system guided by various internal baffles and plates such as item 39. It can be appreciated by those skilled in the art that the drying gas flow need not be recirculated in a rigorously closed loop. It is readily possible within the scope of the invention to have various drying gas purge and makeup streams as is appropriate to the specific drying application.

Since the heat input to the system comes primarily through the material being dried, any temperature drop experienced by the drying gas in other parts of its cycle through the system can be recovered as the drying gas passes over the material being dried and actually receives heat from both contact with the material and from uptake of the heated moisture vapour coming off the material being dried. This is the opposite of existing systems where the drying gas provides heat to the material being dried. Since the sensible heat taken up by the drying gas is small relative to the total heat of evaporation provided by the heat pump condenser, any losses from this reversal are similarly small. As a consequence, the drying gas flow needed to take up the moisture is much lower than it would be if it also had to provide the heat of evaporation to the material being dried which significantly reduces wasteful dry gas fan power or the required temperature difference of the drying gas relative to existing systems. Thus the combination of effects leads to an overall net process efficiency improvement relative to existing systems.

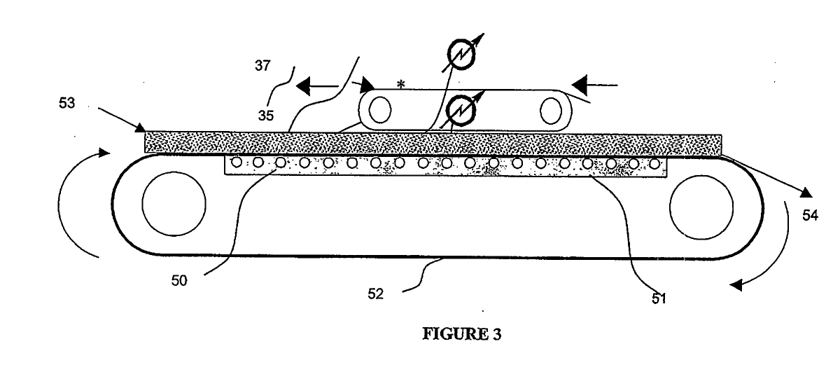

The material being dried enters the system as stream 21 and is optionally preheated by the moisture laden drying gas stream 35. It is then distributed into a high surface area configuration, which in this preferred embodiment is onto a set of moving belt conveyors 23, 24 and 25. In the preferred configuration shown, the conveyor moves the material being dried from left to right in counter current flow to the drying gas. But, it does not materially affect the invention if the movement of the material being dried were in co-current flow with the drying gas stream. The heat pump condenser 29, 30 and 31 acts to provide the heat of evaporation to vaporise the moisture from the material being dried primarily by conduction, preferentially through a tube, plate and belt configuration shown in more detail in FIG. 3. As the material being dried moves along the conveyor and gives off moisture during the drying process, it passes through an optional set of agitation devices 26, 27 and 28 which can act to break up any moisture resistant skin that may form during drying. Once the material is sufficiently dry, it leaves the system as stream 38.

The details of one preferred method for providing the heat from the heat pump condenser more directly into the material being dried rather than through the drying gas medium are shown in FIG. 3. The refrigerant tubes of the heat pump condenser are shown as item 50. The condensing refrigerant transfers heat through the heat exchanger tube walls and into an optional dispersion plate 51. In this embodiment, the dispersion plate is made from a high heat transfer material such as copper or aluminium. In cases where corrosion may be a problem, a thin sheet or film of corrosive resistant material may optionally overlay any dispersion plate. In the embodiment shown, the heat from the heat pump condenser is then transferred through a conductive conveyor 52 to the material being dried. As those who are skilled in the art are aware, the high thermal conductivity of the conveyor and dispersion plate significantly affect the efficiency of the process and should be maximised. The material being dried 53 is spread on the conveyor 52 at the left and dries as the conveyor moves in a clockwise direction before it leaves the conveyor as dry material 54. In this embodiment, the material being dried will be spread such that it has good thermal contact with the conveyor or the condenser heat exchanger tubes if a conveyor and dispersion plate are not needed.

It can be appreciated by those skilled in the art that other waste heat sources or sinks may be available at low cost in certain process environments. In these situations, for the case where the heat pump system is augmented or replaced by an alternate high temperature heat source and lower temperature heat sink, the condensing duty from the heat pump refrigerant working fluid is augmented or replaced by the high temperature heat source in the heat exchange system and the evaporating duty from the heat pump refrigerant working fluid is augmented or replaced by the lower temperature heat sink in the heat exchange system.

It can also be appreciated by those skilled in the art, that additional components specific to the product being dried, such as auxiliary heaters for sterilization can be readily added to the process and apparatus of the invention without materially changing the invention.

Similarly there are various methods and apparatus that can be added to the process and apparatus of this invention to reject any excess heat from the overall process to the ambient environment without materially changing the invention. These include but are not limited to venting a sub-stream of drying gas, pre-cooling the drying gas entering the evaporator, cooling any make-up or purge drying gas entering or leaving the heat pump apparatus, sub-cooling the liquid heat pump refrigerant, de-superheating the heat pump refrigerant leaving the compressor, or partially or wholly condensing the high-pressure refrigerant for purposes of control.

As with other heat pump systems, additional methods of heat recovery may be optionally applied to the invention without material change to the invention. For instance, it is possible to include the capacity for reclaiming sensible cooling at the evaporator using, for example, either a pair of liquid coupled heat exchangers, or by means of heat-pipe coupled heat exchangers. Also, it will be noted that some heat may be added to the recirculating drying gas stream from the heat pump circuit to fine tune and control the process without material change to the invention.

As those skilled in the art will appreciate, the process and apparatus of this invention will provide benefits to drying many different materials. These materials include but are not limited to sewage sludge, meat and vegetable matter processing streams and wastes, dairy processing streams and wastes, paper, bricks, gypsum, plaster board, textiles, china clay, fertilizer, dye stuffs, tiles, pottery, grain, nuts, seeds, fruits, bio-processing waste, etc.

The process and apparatus of this invention are also amenable to various drying gas mediums. Although the preferred embodiment for the invention is with air as the drying gas, the process and apparatus can be configured to use O2-free air, nitrogen, argon, oxygen, or any other gaseous medium to take up the moisture from the materials to be dried and condense that moisture out of the system through the heat pump evaporator. As with other existing heat pump systems, the invention may require means for rejecting excess heat from the drying chamber. This may include desuperheating, condensing or sub-cooling refrigerant leaving the compressor and rejecting heat to the environment. Alternatively the drying gas may be precooled as it enters the evaporator or the dehumidifier more generally.

Also, although the system is preferentially focussed on water removal, it can also be configured to remove other vaporisable and condensable liquids from the material to be dried such as various organic solvents to be recovered from solvent based processing steps including painting.

Although the figures show a preferred embodiment for a conveyor belt material handling system, it can readily be appreciated that minor changes to the drying chamber configuration can be made to facilitate other methods of conveyance such as wiped film systems, in other drying gas mediums and for removing liquids other than water.

In the preferred embodiment for drying an biological paste for a typical feed with 25% solids content (300% moisture content dry basis) and drying to an 80% solids content (25% moisture content dry basis), the nominal conditions are summarised in Table 1:

TABLE 1

| Biological Paste Drying Example Parameter | Range | |
|---|---|---|
| Dry bulb temperature of drying gas (average | 35-70 | C. |
| over the system) | | |
| Wet bulb temperature of drying gas (average | 20-65 | C. |
| over the system) | | |
| Drying gas velocity over the material being | 1-5 | m/s |
| dried | | |
| Approach temperature in heat pump condenser | 2-25 | C. |
| Approach temperature in heat pump evaporator | 2-45 | C. |
| Drying gas temperature drop across evaporator | 3-35 | C. |
| heat exchanger | | |
| Condenser temperature heat pump fluid side | 40-85 | C. |
| Evaporator temperature heat pump fluid side | 20-65 | C. |

Computational models of the efficiency of organic paste drying in a conventional heat pump system with drying gas heating and cooling and in a conventional combustion heat driven system were compared to similar models for the efficiency of paste drying using a preferred embodiment of the invention. The case considered was for a wet paste feed containing 30% solids on a total mass basis with a dry product of 83% solids on a total mass basis for a system capable of removing 390 kg/hour of moisture. The results are summarised in Table 2.

TABLE 2

| | The | Existing Thermal | Existing Heat |
|---|---|---|---|
| | Invention | System | Pump Systems |
| Combustion Heat | 0 | 380 kW | 0 |
| Electrical Power | 42 kW | 50 kW | 130 kW |
| Estimated annual cost | $33,600 | $161,600 | $104,000 |
| @ $0.10/kWh electric & | | | |
| $0.04/kWh combustion | | | |
| Estimated Operating | | $128,000 | $70,400 |
| Savings $ per year for | | | |
| the invention relative | | | |
| to other existing options | | | |

Comparison of the two processes shows that the overall drying efficiency is significantly higher when the heat of evaporation is directly supplied to the material being dried by conduction rather than by the drying gas stream. Thus the invention achieves a substantial performance benefit relative to the prior art heat pump drying systems.

It will be appreciated that the invention is not restricted to the particular embodiments and modifications described above and that numerous modifications and variations can be made without departing from the scope of the invention.

1. A heat exchange system for a drying apparatus including:
a drying gas to remove moisture from the material being dried, and
a heat source heat exchanger containing a heat source medium to heat the material being dried primarily by conduction and/or convection configured in such a way that the majority of heat transferred to the material being dried does not first pass through the drying gas stream so the drying gas stream primarily carries moisture away from the material being dried but does not carry the majority of heat into the material being dried, and
a heat sink heat exchanger containing a heat sink medium to cool and condense liquid out of a drying gas.

2. A heat exchange system according to claim 1 where at least part of the heat sink heat exchanger is an evaporator in a heat pump system.

3. A heat exchange system according to claim 2 where at least part of the heat source heat exchanger is a condenser in a heat pump system.

4. A heat exchange system according to claim 1 with the heat source heat exchanger configured such that the heat is distributed from the heat source medium through a fixed heat conduction medium and then into the material being dried.

5. A heat exchange system according to claim 4 where the fixed heat conduction medium is a thermally conducting plate with internal passages through which the heat source material flows.

6. A heat exchange system according to claim 4 where the material being dried is moved across the fixed heat conduction medium on a moving belt in thermal contact with the fixed heat conduction medium.

7. A heat exchange system according to claim 4 where the material being dried is spread over the fixed heat conduction medium and then removed after releasing some of its moisture to the drying gas.

8. A heat exchange system according to claim 1 arranged to operate with the drying gas at a temperature between 25 and 90C.

9. A heat exchange system according to claim 1 including means for rejecting heat from the drying apparatus to the external environment such as full time or periodic drying gas venting, pre-cooling the drying gas entering the evaporator, pre-cooling any make-up or purge drying gas entering or leaving the apparatus, sub-cooling the liquid heat pump refrigerant after it leaves the condenser and before it enters the evaporator, de-superheating the heat pump refrigerant leaving the compressor, or partially or wholly condensing the high-pressure refrigerant for purposes of control.

10. A heat sink exchange system according to claim 1 arranged so that the drying gas passes over a substantially closed loop path repeatedly through the heat exchange system and past or through a drying zone containing a material to be dried.

11. A drying apparatus including:
a drying chamber where material is dried,
a drying gas to remove moisture from the material being dried, and
a heat source heat exchanger containing a heat source medium to heat the material being dried primarily by convection and/or conduction configured in such a way that the majority of heat transferred to the material being dried does not first pass through the drying gas stream so the drying gas stream primarily carries moisture away from the material being dried but does not carry the majority of heat into the material being dried, and
a heat sink heat exchanger containing a heat sink medium to cool and condense liquid out of a drying gas.

12. A heat pump for a drying apparatus including:
a condenser to heat the material being dried primarily by convention and/or conduction configured in such a way that the majority of heat transferred to the material being dried does not first pass through the drying gas stream so the drying gas stream primarily carries moisture away from the material being dried but does not carry the majority of majority of heat into the material being dried, and
an evaporator to cool and condense liquid out of a drying gas.

13. A heat exchange apparatus operable in a drying apparatus including:
a hot heat exchanger to heat the material being dried primarily by convection and/or conduction configured in such a way that the majority of heat transferred to the material being dried does not first pass through a drying gas stream so the drying gas stream primarily carries moisture away from the material being dried but does not carry the majority of heat into the material being dried, and
a cold heat exchanger to cool and condense liquid out of a drying gas.

14. A process for drying a material including:
causing a drying gas to remove moisture from the material being dried, and
heating the material being dried primarily by convection and/or conduction with a heat source heat exchanger containing a heat source medium where the majority of heat transferred to the material being dried does not first pass through the drying gas stream so the drying gas stream primarily carries moisture away from the material being dried but does not carry the majority of heat into the material being dried, and
cooling and condensing liquid out of a drying gas with a heat sink heat exchanger containing a heat sink medium and a heat sink heat transfer surface.

15. A drying process according to claim 14 wherein at least part of the heat sink heat exchanger is an evaporator in a heat pump system.

16. A drying process according to claim 15 wherein at least part of the heat source heat exchanger is a condenser in a heat pump system.

17. A drying process according to claim 14 with the heat source heat exchange configured such that the heat is distributed from the heat source medium through a fixed heat conduction medium and then into the material being dried.

18. A drying process according to claim 17 where the fixed heat conduction medium is a thermally conducting plate with internal passages through which the heat source material flows.

19. A drying process according to claim 17 where the material being dried is moved across the fixed heat conduction medium on a moving belt in thermal contact with the fixed heat conduction medium.

20. A drying process according to claim 17 where the material being dried is spread over the fixed heat conduction medium and then removed after releasing some of its moisture to the drying gas.

21. A drying process according to claim 14 including operation with the drying gas at a temperature between 25 and 90C.

22. A drying process according to claim 14 including rejecting heat from the drying apparatus to the external environment such as full time or periodic drying gas venting, pre-cooling the drying gas entering the evaporator, pre-cooling any make-up or purge drying gas entering or leaving the apparatus, sub-cooling the liquid heat pump refrigerant after it leaves the condenser and before it enters the evaporator, de-superheating the heat pump refrigerant leaving the compressor, or partially or wholly condensing the high-pressure refrigerant for purposes of control.

23. A drying process according to claim 14 arranging the drying gas to pass over a substantially closed loop path repeatedly through the heat exchange system and past or through a drying chamber for containing a material to be dried.

24. A heat pump apparatus operable in a drying apparatus with the heat pump evaporator in primary thermal contact with a drying gas medium after said drying gas medium has taken up moisture from the material being dried and the heat pump condenser in primary thermal contact with the material being dried and with both the drying gas medium and the heat pump refrigerant in nominally closed loop circulation paths.

25. A heat pump and drying apparatus including a drying chamber, a heat exchange apparatus and a drying gas stream, wherein the heat exchange apparatus includes a colder heat pump evaporator heat exchanger and a hotter heat pump condenser heat exchanger arranged such that during operation, the colder evaporator heat exchanger substantially exchanges heat with the moisture rich drying gas stream, and the hotter condenser heat exchanger substantially exchanges heat with the material being dried primarily by convection and/or conduction rather than the moisture lean drying gas stream.

26. A heat pump driven drying process with a drying gas stream, wherein the heat exchange is performed though a colder heat pump evaporator heat exchanger and a hotter heat pump condenser heat exchanger arranged such that during operation, the colder evaporator heat is exchanged substantially with the moisture rich drying gas stream, and the hotter condenser heat is exchanged substantially with the material being dried primarily by convection and/or conduction rather than the moisture lean drying gas stream.
